(19) United States
(12) Patent Application Publication
(10) Pub. No.: US 2005/0001916 A1
(43) Pub. Date: Jan. 6, 2005

(54) Imaging device

(76) Inventor: Hisashi Takita, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/807,688

(22) Filed: Mar. 24, 2004

(30) Foreign Application Priority Data
Mar. 26, 2003 (JP) P2003-084146

(51) Int. Cl. H04N 5/335

(52) U.S. Cl. 348/308

(57) ABSTRACT

It is an object of the present invention to make noise which contains regularities, which is likely to be generated in an image of an image signal obtained by using a CMOS sensor, less conspicuous. A CMOS sensor 50 includes a plurality of photoelectric conversion units 51-xy, which generate by photoelectric conversion pixel signals for respective pixels which together form an image and are arranged vertically and horizontally, and a plurality of wirings 52-x. Photoelectric conversion units 51-x0, 51-x1, 51-x2, and the like, which are arranged in the vertical direction, are not necessarily connected to the CDS unit 41-x of the signal correction unit 5 via a wiring 52-x. Each of the conversion units is connected to a CDS unit 41-z which is different from those of adjacent the photoelectric conversion units 51 in all four directions via the wiring 52-z. Here, z indicates a coordinate in the horizontal direction, which is a random value without regularity. The present invention can be applied to, for example, a CMOS sensor.

### BACKGROUND OF THE INVENTION

1. Field of the Invention

The present invention relates to an imaging device, and in particular to an imaging device which is adapted to prevent noise that contains regularities from being generated in an image formed of pixel signals which are received.

2. Description of the Related Art

Conventionally, an imaging device, which converts an optical image of a subject into an electric signal, that is, performs photoelectric conversion, is mounted to electronic apparatuses such as a digital still camera and a digital video camera which acquire an image as a digital signal.

As the imaging device, there is known a CCD (Charge Coupled Device) sensor and a CMOS sensor. Here, the CMOS sensor is a sensor which can be manufactured on the basis of a CMOS-LSI process. However, the entire structure of the CMOS sensor is not necessarily manufactured only by the CMOS-LSI process.

It is known that, compared with the CCD sensor, the CMOS sensor has advantages in that an enormous number of pixels can be arranged at high density, readout of a pixel signal is very fast, power consumption is low, and production cost is low, and has disadvantages in that noise is contained in a pixel signal and fluctuation occurs in pixel accuracy.

FIG. 1 shows an example of a structure of a general digital video camera mounted with the CMOS sensor. This digital video camera 1 generally includes: an optical system; a signal processing system; a recording system; a display system; and a control system.

The optical system of the digital video camera 1 includes: a lens 2 which condenses an optical image of a subject; a stop 3 which adjusts the amount of light of the optical image; and a CMOS sensor 4 which photoelectrically converts the condensed optical image at a predetermined frame rate and generates a pixel signal.

The signal processing system includes: a signal correction unit 5 which reduces noise by sampling the pixel signals generated by the CMOS sensor 4; an A/D converter 6 which subjects the pixel signal, from which noise has been removed by the signal correction unit 5, to AD conversion; and a DSP (Digital Signal Processor) which generates an image signal on the basis of the digital pixel signal outputted by the A/D converter 6.

The recording system of the digital video camera 1 includes: a CODEC (Compression/Decompression) 12 which encodes the image signal inputted from the DSP 7 and records the image signal in a memory 13, reads out and decodes encoded data recorded in the memory 13, and supplies an image signal obtained as a result of reading out and decoding the encoded data to the DSP 7; and a memory 13 consisting of a magnetic disk, an optical disk, a magneto-optical disk, a semiconductor, or the like which stores the encoded data.

The display system of the digital video camera 1 includes: a D/A converter 9 which subjects the image signal supplied from the DSP 7 to DA conversion; a video encoder 10 which converts a color image formed of pixels composed of all components of R, G and B combined, which is outputted by the D/A converter 9, into ordinary video signals such as luminance Y and color differences Cr and Cb and outputs the video signals to a display 11; and a display 11 which consists of an LCD (Liquid Crystal Display) or the like which functions as a finder and a video monitor by displaying an image corresponding to the video signals.

The control system of the digital video camera 1 includes: a timing generator (TG) 8 which controls operation timing of the CMOS sensor 4 or the DSP 7; an input device 15 which receives various operations from a user; and a CPU (Central Processing Unit) 14 which controls the entire digital video camera 1.

FIG. 2 shows an example of detailed structures of the CMOS sensor 4 and the signal correction unit 5. In the CMOS sensor 4, a plurality of photoelectric conversion units 31, which generate pixel signals of respective pixels forming an image according to photoelectric conversion, are arranged vertically and horizontally. The photoelectric conversion unit 31 corresponding to a pixel of coordinates (x, y) will be hereinafter referred to as a photoelectric conversion unit 31-xy.

Photoelectric conversion units 31-00, 31-01, 31-02, and the like arranged in the vertical direction are connected to a CDS (Correlated Double Sampling) unit 41-0 of the signal correction unit 5 via a vertical wiring 32-0. Photoelectric conversion units 31-10, 31-11, 31-12, and the like arranged in the vertical direction are connected to a CDS unit 41-1 of the signal correction unit 5 via a vertical wiring 32-1. In the same manner, photoelectric conversion units 31-x0, 31-x1, 31-x2, and the like arranged in the vertical direction are connected to a CDS unit 41-x of the signal correction unit 5 via a vertical wiring 32-x.

The CDS unit 41-0 of the signal correction unit 5 removes noise of pixel signals which are inputted from the photoelectric conversion units 31-00, 31-01, 31-02, and the like via the vertical wiring 32-0, corrects variations among the respective pixel signals due to fluctuation in performance of the respective photoelectric conversion units 31-00, 31-01, 31-02, and the like, and outputs the pixel signals to the A/D converter 6 in a later stage. The CDS unit 41-1 removes noise of pixel signals which are inputted from the photoelectric conversion units 31-10, 31-11, 31-12, and the like via the vertical wiring 32-1, corrects variations among the respective pixel signals due to fluctuation in performance of the respective photoelectric conversion units 31-10, 31-11, 31-12, and the like, and outputs the pixel signals to the A/D converter 6 in a later stage. In the same manner, the CDS unit 41-x removes noise of pixel signals, which are inputted from the photoelectric conversion units 31-x0, 31-x1, 31-x2, and the like via the vertical wiring 32-x, corrects variations among the respective pixel signals due to fluctuation in performance of the respective photoelectric conversion units 31-x0, 31-x1, 31-x2, and the like, and outputs the pixel signals to the A/D converter 6 in a later stage.

Incidentally, the CDS units 41-0, 41-1, 42-2, and the like constituting the signal correction unit 5 also vary among themselves in performance of correction processing thereof. Thus, although fluctuation is prevented for pixel signals of pixels aligned vertically among pixel signals to be inputted to the A/D converter 6, it is likely that fluctuation still occurs among pixel signals of each vertical line. Therefore, noise in the form of vertical stripes may be generated in an image of an image signal finally obtained.

In addition, in the above description, attention is paid to fluctuation of the CDS unit provided at an end of a wiring (signal line) for each pixel column. However, fluctuation is not limited to the CDS unit only. The influence of the same fluctuation appears as vertical stripe noise for each pixel column in an imaging device in which a signal processing circuit is generally provided at the end of the signal line for each pixel column.

Since noise having regularity such as vertical stripes tends to be visually perceived and cause discomfort in those who see it, some countermeasure is required. However, conventionally, it is the main objective to correct pixel signals so that variations among the pixel signals is eliminated, and a method of making the noise less conspicuous easily has not been devised.

### SUMMARY OF THE INVENTION

The present invention has been devised in view of such a situation, and it is an object of the present invention to make noise having regularity, which is generated in an image of an image signal obtained by using a CMOS sensor, less conspicuous.

The present invention provides an imaging device which generates pixel signals of pixels forming an image and supplies the pixel signals to a plurality of correction means for correcting the pixel signals, the imaging device including: a plurality of photoelectric conversion means which are arranged vertically and horizontally and generate pixel signals according to photoelectric conversion; supply means which supplies pixel signals generated by the photoelectric conversion means to correction means which are different from correction means to which pixel signals generated by the adjacent photoelectric conversion means are supplied.

The present invention also provides an imaging device including: a plurality of pixels which are arranged in an imaging device and generate a signal of a level corresponding to the amount of received light; and a plurality of signal lines each of which is arranged for each column of the plurality of pixels, wherein one pixel column of the plurality of pixels includes at least a first pixel and a second pixel, a signal from the first pixel is read out to a signal processing circuit, which is provided at an end of a first signal line included in the plurality of signal lines, through the first signal line, and a signal from the second pixel is read out to a signal processing circuit, which is provided at an end of a second signal line included in the plurality of signal lines, through the second signal line different from the first signal line.

An imaging device of the present invention is characterized by including: a plurality of photoelectric conversion means which are arranged vertically and horizontally and generate pixel signals according to photoelectric conversion; supply means which supplies pixel signals generated by the photoelectric conversion means to correction means different from correction means to which pixel signals generated by photoelectric conversion means adjacent to the photoelectric conversion means are supplied.

The imaging device may be a CMOS sensor.

The correction unit may be a CDS processing circuit. The supply means may be adapted to supply pixel signals generated by the photoelectric conversion means to a CDS processing circuit different from the CDS processing circuit to which pixel signals generated by the adjacent photoelectric conversion means are supplied.

In the imaging device of the present invention, pixel signals are generated according to photoelectric conversion, and the generated pixel signals are supplied to correction means different from the correction means to which signals of adjacent pixels are supplied.

### BRIEF DESCRIPTION OF THE DRAWINGS

In the accompanying drawings:

FIG. 1 is a block diagram showing an example of a structure of a conventional general digital video camera;

FIG. 2 is a block diagram showing an example of a structure of a conventional CMOS sensor;

FIG. 3 is a block diagram showing an example of a structure of a CMOS sensor which is an embodiment of the present invention; and

FIG. 4 is a block diagram showing an example in which the present invention is applied to an imaging device provided with an AD conversion circuit for each pixel column.

### DESCRIPTION OF THE PREFERRED EMBODIMENTS

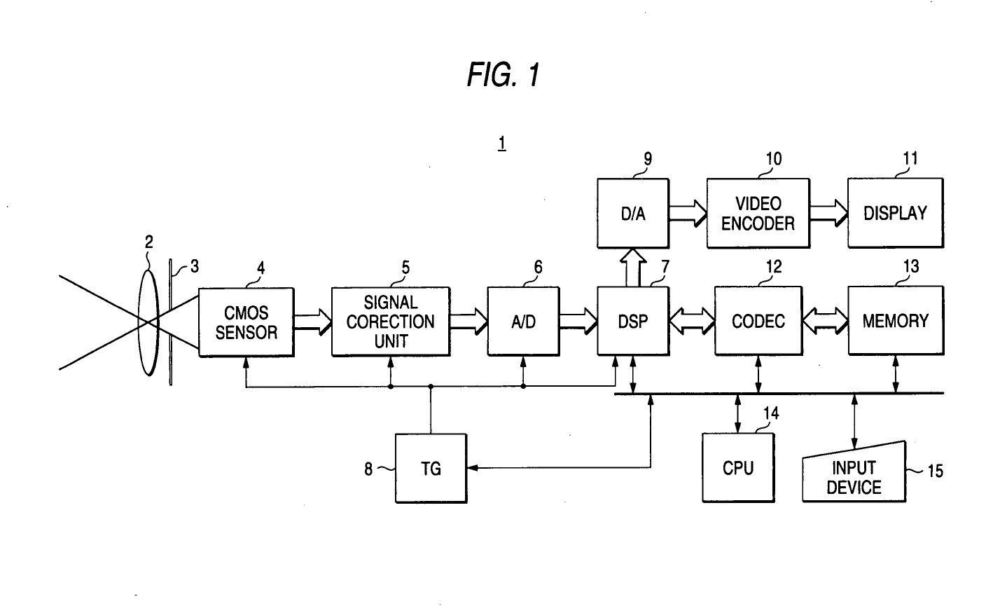

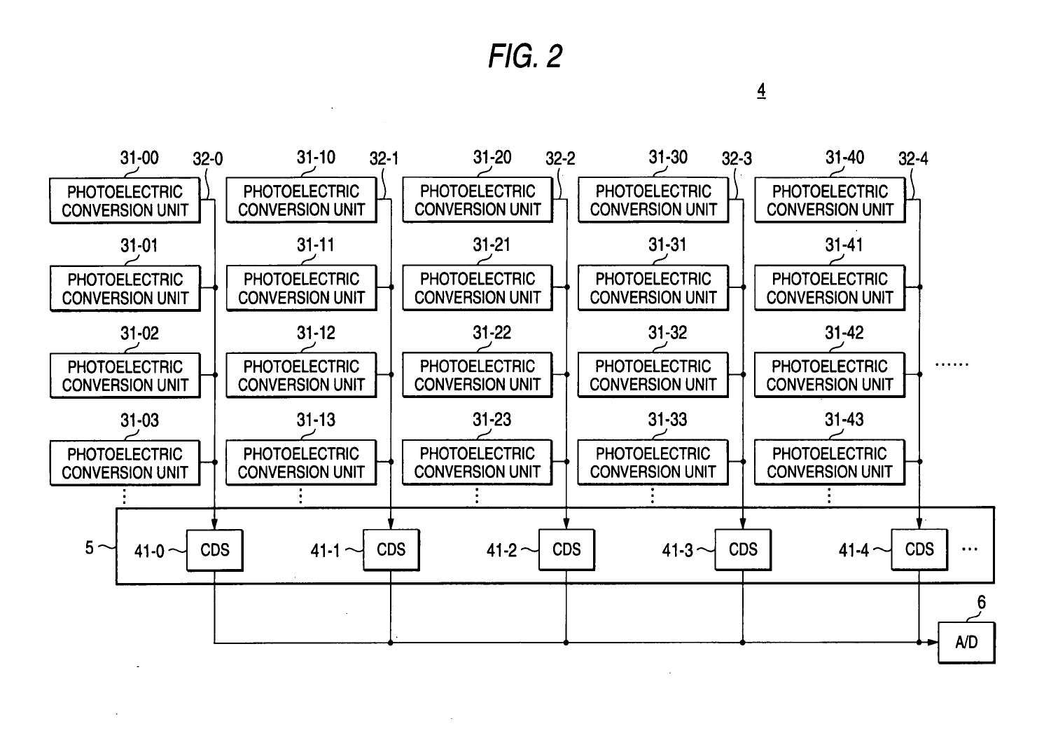

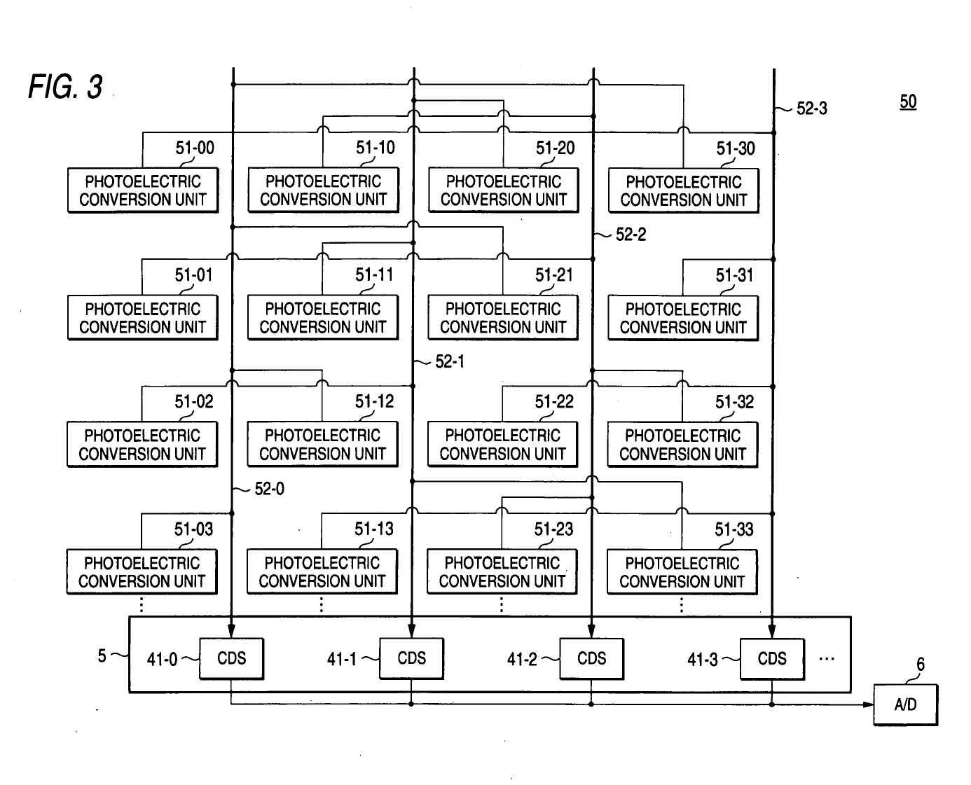

FIG. 3 shows an example of a structure of a CMOS sensor which is an embodiment of the present invention. This CMOS sensor 50 is used for the structure of the digital video camera 1 of FIG. 1 instead of the conventional CMOS sensor 4 shown in FIG. 2.

The CMOS sensor 50 includes a plurality of photoelectric conversion units 51-xy, which generate pixel signals of respective pixels forming an image signal according to photoelectric conversion and are arranged vertically and horizontally, and a plurality of wirings 52-x. Here, it is assumed that x and y indicate coordinates of a pixel. A photoelectric conversion unit corresponding to a pixel of coordinates (x, y) will be hereinafter referred to as a photoelectric conversion unit 51-xy.

Pixel signals outputted from the CMOS sensor 50 are inputted to a signal correction unit 5. As in the structure shown in FIG. 2, the signal correction unit 5 includes CDS units 41-0, 41-1, 42-2, and the like. The CDS units 41-0, 41-1, 42-2, and the like vary among themselves in performance of correction processing thereof.

Photoelectric conversion units 51-00, 51-01, 51-02, and the like, which are arranged in the vertical direction, are not necessarily connected the CDS unit 41-0 of the signal correction unit 5 via a wiring 52-0. Each of the conversion units is connected to a CDS unit 41-z, which is different from those of the adjacent photoelectric conversion units 51 in all four directions, via a wiring 52-z. Here, z indicates a coordinate in the horizontal direction, which is a random value without regularity.

Photoelectric conversion units 51-10, 51-11, 51-12, and the like, which are arranged in the vertical direction, are not necessarily connected to the CDS unit 41-1 of the signal correction unit 5 via a wiring 52-1. Each of the conversion units is connected to the CDS unit 41-z, which is different from those of the adjacent photoelectric conversion units 51 in all four directions, via the wiring 52-z. Here, z indicates a coordinate in the horizontal direction, which is a random value without regularity.

In the same manner, photoelectric conversion units 51-x0, 51-x1, 51-x2, and the like, which are arranged in the vertical direction, are not necessarily connected to the CDS unit 41-x of the signal correction unit 5 via a wiring 52-x. Each of the conversion units is connected to the CDS unit 41-z, which is different from those of the adjacent photoelectric conversion units 51 in all four directions, via the wiring 52-z. Here, z indicates a coordinate in the horizontal direction, which is a random value without regularity.

The CDS unit 41-0 of the signal correction unit 5 removes noise of pixel signals, which are inputted via the wiring 52-0, corrects variations among the respective pixel signals, and outputs the pixel signals to an A/D converter 6 in a later stage. The CDS unit 41-1 removes noise of pixel signals which are inputted via the vertical wiring 52-1, and corrects variations among the respective pixel signals, and outputs the pixel signals to the A/D converter 6 in the later stage. In the same manner, the CDS unit 41-x removes noise of pixel signals which are inputted via the vertical wiring 52-x, corrects variations among the respective pixel signals, and outputs the pixel signals to the A/D converter 6 in a later stage.

Therefore, respective pixel signals of the image which is obtained finally are corrected by one of the CDS units 41-0, 41-1, 42-2, . . . which is different from those correcting pixel signals of the adjacent pixels in all four directions.

As described above, the CDS units 41-0, 41-1, 42-2, and the like vary among themselves in performance of correction processing. However, the influence of this fluctuation is not visually conspicuous in the form of a vertical fringe, horizontal fringe, or the like, and the noise in the image which is obtained finally is random; that is, without regularity. Therefore, it becomes possible to reduce visual discomfort caused in those who see the image.

Note that the CMOS sensor 50 which the present invention utilizes merely replaces the conventional CMOS sensor 4 as described above. Thus, compared with the conventional CMOS sensor 4, additional operations for correction are not required. Therefore, the above-mentioned effect can be obtained without increasing time required until a final image signal is obtained.

In addition, it is possible to apply the CMOS sensor 50, to which the present invention is applied, to all electronic apparatuses which generate a digital image signal on the basis of an optical image of a digital still camera, a scanner, or the like, as well as a digital video camera.

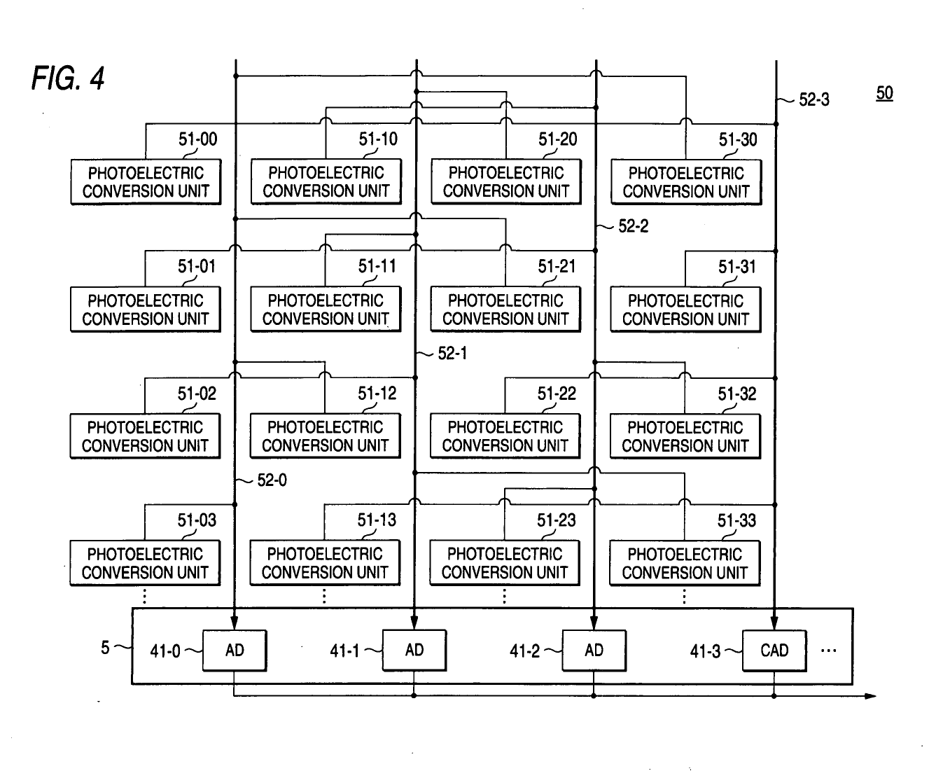

In addition, in the above-mentioned embodiment, the imaging device provided with a CDS unit for each pixel column is described. However, the present invention can be applied not only to the imaging device provided with a CDS unit but also to an imaging device which is provided with a general signal processing circuit, such as an AD conversion unit, for each pixel column. In FIG. 4, an imaging device provided with an AD conversion circuit for each pixel column, to which the present invention is applied, is shown.

As described above, according to the present invention, it becomes possible make noise containing regularities, which is likely to be generated in an image of an image signal obtained by using a CMOS sensor, less conspicuous.

1. An imaging device which generates pixel signals for pixels which form an image and supplies said pixel signals to a plurality of correction means for correcting said pixel signals, the imaging device comprising:
a plurality of photoelectric conversion means which are arranged vertically and horizontally and generate pixel signals by photoelectric conversion;
supply means which supplies pixel signals generated by said photoelectric conversion means to correction means different from the correction means to which pixel signals generated by adjacent photoelectric conversion means are supplied.

2. An imaging device according to claim 1,
wherein said imaging device is a CMOS (Complementary Meta-Oxide Semiconductor).

3. An imaging device according to claim 1,
wherein said correction means is a CDS (Correlated Double Sampling) processing circuit, and
said supply means supplies pixel signals generated by said photoelectric conversion means to a CDS processing circuit different from the CDS processing circuit to which pixel signals generated by the adjacent photoelectric conversion means are supplied.

4. An imaging device comprising:
a plurality of pixels which are arranged in an imaging area and generate a signal of a level corresponding to the amount of received light; and
a plurality of signal lines each of which is arranged for each column of said plurality of pixels,
wherein one pixel column of said plurality of pixels includes at least a first pixel and a second pixel,
a signal from said first pixel is read out to a signal processing circuit which is provided at an end of a first signal line included in said plurality of signal lines, through said first signal line, and
a signal from said second pixel is read out to a signal processing circuit which is provided at an end of a second signal line included in said plurality of signal lines, through said second signal line different from said first signal line.

5. An imaging device according to claim 4,
wherein said signal processing circuit includes an AD conversion circuit.
